(19) United States
(12) Patent Application Publication
(10) Pub. No.: US 2016/0302546 A1
(43) Pub. Date: Oct. 20, 2016

(54) HAIR CURLER

(71) Applicant: Wenzhou Lena Electric Technology Corp., Wenzhou (CN)

(72) Inventor: Maochang Fan, Zhejiang (CN)

(73) Assignee: Wenzhou Lena Electric Technology Corp., Wenzhou (CN)

(21) Appl. No.: 14/832,367

(22) Filed: Aug. 21, 2015

(30) Foreign Application Priority Data
Apr. 17, 2015 (CN) 201520592991.7
Aug. 7, 2015 (CN) 201510483351.7

(51) Int. Cl. A45D 1/04; A45D 19/16; H05B 3/22

(52) U.S. Cl. CPC A45D 1/04; H05B 3/22; A45D 19/16

(57) ABSTRACT

The invention discloses a hair curler, including the first plate and second plate, the first plate is equipped with the first heater, and the second plate is equipped with the second heater. When the first plate and the second plate are in closed condition, there will be a reserved space of 0.06 mm to 0.12 mm between the first heater and the second heater. When the strand of hair is fewer between the first heater and the second heater in the use of the appliance, hold the plates until to nearly closed condition, considering there is a reserved space of 0.06 mm to 0.12 mm between the two heaters, while the dimension of human hair is about 0.08 mm, that means the strand of hair between the plates won't be grasped firmly. In this way, the clamping force caused when closing the plates will be greatly reduced, the hair will go smoothly through the reserved space without getting clamped off or damaged by the large clamping force.

### FIELD OF THE INVENTION

The invention involves the technology field of hairdressing tools, especially involves one kind of hair curler.

### BACKGROUND OF THE INVENTION

At present, there are already some hair curlers are for both straightening and curling, with the main structure of handle, heating plates and hair curler. However, the heating plates of these hair curlers are quite easy clamp off or damage the hair during straightening or curling, as the hairs that placed between the plates is fewer while the clamping force of the heating plates is large. In addition, the temperature of the hair curler will become quite hot when the plates reach a high temperature, which may burn the skin of the user when using the appliance, will cause lots of inconvenience to the users.

Therefore, to provide a hair curler which won't clamp the hair off easily is a technical problem that the technicians in this field need to solve.

### SUMMARY OF THE INVENTION

In view of this, the invention provides a hair curler that won't clamp the hair off easily and avoid the hair from damage during curling.

In order to solve the stated problem, the invention provides a hair curler, including the first plate and the second plate. The stated first plate is equipped with the first heater, and the stated second plate is equipped with the second heater. When stated the first plate and the stated second plate are in closed condition, there will be a reserved space of 0.06 mm to 0.12 mm between the first heater and the second heater.

Preferably, in the hair curler above stated, the stated first plate hinges the stated second plate by flexible hinge. The stated flexible hinge is equipped with position limiter which limits the relatively rotation of the stated first plate and the stated second plate. The stated second plate is equipped with limited step which is corresponding to the stated position limiter.

Preferably, in the hair curler above stated, both ends of the stated first plate and the stated second plate are equipped with a supportive bulge. The stated supportive bulges contact each other.

Preferably, in the hair curler above stated, the stated supportive bulges are spherical bulges.

Preferably, in the hair curler above stated, it is equipped with pressure springs between the stated first heater and the stated first plate, and also the stated second heater and the stated second plate.

Preferably, in the hair curler above stated, it is equipped with 2 stated pressure springs between the first heater and the stated first plate, and also 2 stated pressure springs between the second heater and the stated second plate. The strain range of each stated pressure spring is 0.245N˜0.686N.

Preferably, in the hair curler above stated, it is equipped with clamp at the end of the stated first plate which used for opening the stated first plate and the stated second plate. The strain range of stated clamp is 8N˜16.89N.

Preferably, in the hair curler above stated, there are many heat evacuation holes on the surface of stated supportive bulges.

Preferably, in the hair curler above stated, both coatings of the stated first plate and the stated second plate are sprayed with heat sensitive color-change painting.

Preferably, in the hair curler above stated, there are grooves for steam emission on the stated first heater and (or) the stated second heater.

The invention provides a hair curler, including the first plate and second plate, the first plate is equipped with the first heater, and the second plate is equipped with the second heater. When the first plate and the second plate are in closed condition, there will be a reserved space of 0.06 mm to 0.12 mm between the first heater and the second heater. When the strand of hair is fewer between the first heater and the second heater in the use of the appliance, hold the plates until to nearly closed condition, considering there is a reserved space of 0.06 mm to 0.12 mm between the two heaters, while the dimension of human hair is about 0.08 mm, that means the strand of hair between the plates won't be grasped firmly. In this way, the clamping force caused when closing the plates will be greatly reduced, the hair will go smoothly through the reserved space without getting clamped off or damaged by the large clamping force.

### BRIEF DESCRIPTION OF THE DRAWINGS

In order to explain the technical scheme in the implement case of the invention or the existing technology, below is a brief introduction of the illustrations used in the implement of the invention or the technical scheme. Obviously, the illustrations described in below are only some implements of the invention; for normal technicians in this field, they could obtain other illustrations from these illustrations without paying creative work.

FIG. 1 is the overall structure diagram of the hair curler in the implement of the invention

FIG. 2 is the cutaway view for FIG. 1

FIG. 3 is the drawing of partial enlargement of Part A of FIG. 2

FIG. 4 is the drawing of partial enlargement of Part B of FIG. 2

FIG. 5 is the left view for FIG. 1

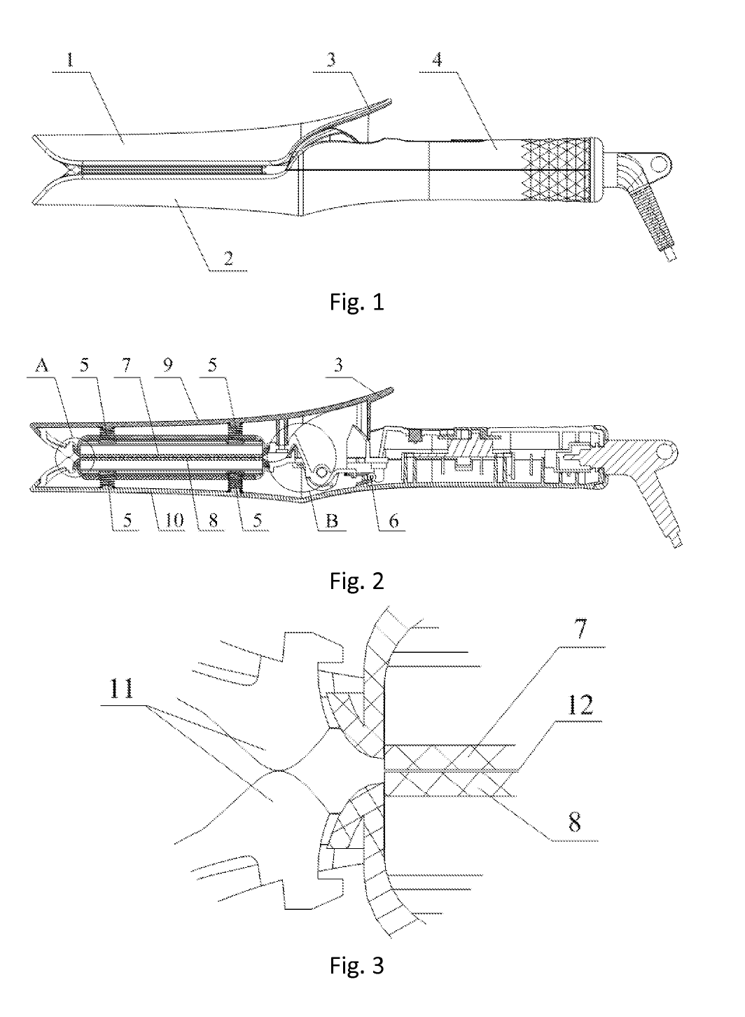

From FIG. 1 to FIG. 5:

### DETAILED DESCRIPTION OF THE PREFERRED EMBODIMENTS

The following text will describe clearly and completely explain the technical scheme in the implement cases of the invention. Apparently, the implement cases are only a few implement cases, not all the implement cases of the invention. Based on implement cases of the invention, all the other implement cases created without creative work by the ordinary technicians in this field, belongs to the protect range of the invention.

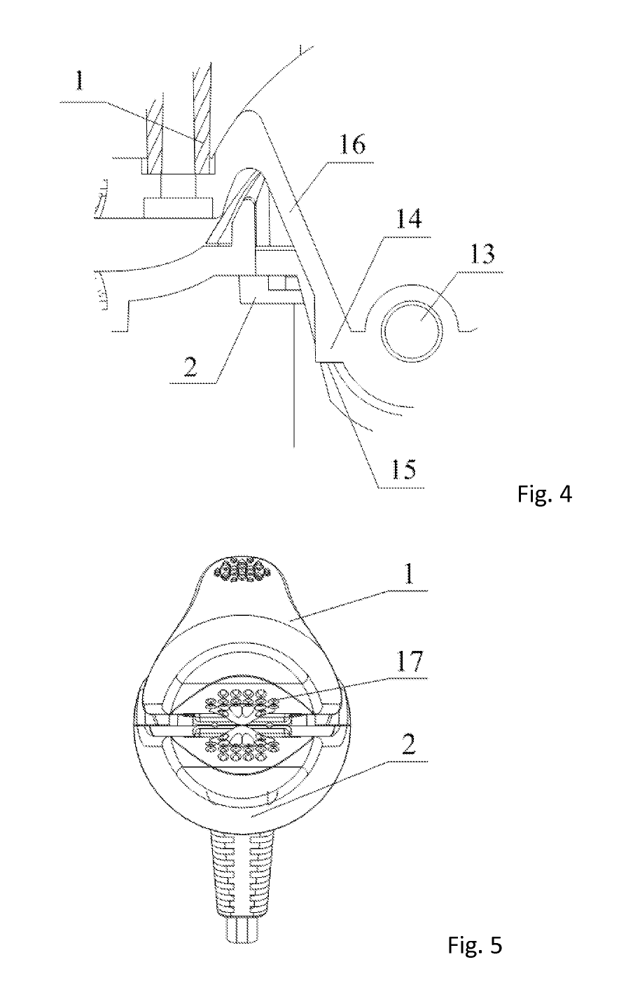

Please refer to FIG. 1 to FIG. 5, FIG. 1 is the overall structure diagram of the hair curler in the implement of the invention; FIG. 2 is the cutaway view for FIG. 1; FIG. 3 is the drawing of partial enlargement of Part A of FIG. 2; FIG. 4 is the drawing of partial enlargement of Part B of FIG. 2; FIG. 5 is the left view for FIG. 1.

In a specific implement case of the scheme, the invention provides a kind of hair curler. The hair curler includes the handle 4, the first plate and the second plate. The first plate and the second plate are mainly used for straightening and curling hair. The stated first plate 1 is equipped with first heater 7, and the stated second plate 2 is equipped with the second heater 8. The first heater 7 and the second heater 8 are placed relatively, used for straightening the hair. The housing of the first plate 1 and the second plate 2 are designed as arc surface, making the hair curler with both straightening and curling function for hair. In order to make sure the all the hairs could go the plates smoothly, the scheme makes that there is a reserved space 12 of 0.06 mm to 0.12 mm between the first heater 7 and the second heater 8 when the first plate 1 and second plate 2 at closed condition.

To be sure, the closed condition of the first plate 1 and the second plate 2 refers to the minimum angled state formed when the two plates are not in open condition, in this condition, the distance of the two plates is the minimum.

To be specific, when the strand of hair is fewer between the first heater 7 and the second heater 8 in the use of the appliance, hold the plates until to nearly closed condition, considering there is a reserved space 12 of 0.06 mm to 0.12 mm between the two heaters, while the dimension of human hair is about 0.08 mm, that means the strand of hair between the plates won't be grasped firmly. In this way, the clamping force caused when closing the plates will be greatly reduced, the hair will go smoothly through the reserved space 12 without getting clamped off or damaged by the large clamping force.

To be sure, there are many structure forms to form the reverse space 12 between the first heater 7 and the second heater 8. Such as to make the two sides of the heaters with bulges, or equip with bulges to support the heater 7 and the second heater 8 at the other position of the first plate 1 and the second plate 2. Preferably the invention chose the latter scheme. To be specific, the first plate 1 in the scheme hinges the second plate 2 by flexible hinge, which is quite similar with the flexible hinge in existing technology. In order to support the two heaters, the scheme designed flexible hinge is equipped with position limiter 14 which limits the relatively rotation of the first plate 1 and the second plate 2. The second plate 2 is equipped with limited step 15 which is corresponding to the position limiter 14, as shown in FIG. 4. To be specific, the flexible hinge includes central axis 13, the pressure lever 16 and the torsion spring 6. The first plate 1 connects the central axis 13 with one of lever arms of pressure lever 16, and rotates around central axis 13. The other lever arm of the pressure lever 16 acts on the torsion spring 6, thus will transfer the elasticity of the torsion spring 6 to the first plate 1, thus makes the first plate 1 and the second plate 2 clamped. The implement case of the scheme place the position limiter 14 on the pressure lever 16 and place the limited step 15 inside the second plate 2. With the position limiter 14 and the limited step 15 placed, the minimum angle between the first plate 1 and the second plate 2 is restricted and avoid the direct contact of these two heaters, this is how the reverse space 12 formed.

Considering the position limiter 14 may be worn after long time use of the opening and closing movement of the flexible hinge, the scheme used another structure to support the second position so as to keep the reverse space 12 for a certain space. Preferably, both ends of the first plate 1 and the stated second plate 2 are equipped with a supportive bulge 11. The stated supportive bulges 11 contact each other. When the first plate 1 and the second plate 2 contact, the two supportive bulges 11 will also contact, thus prop up the other side of these two heaters, make sure the reverse space 12 will not narrow down or disappear, as shown in FIG. 3. More preferably, the supportive bulges in the scheme are spherical bulges which decrease the contact area of the supportive bulges 11, in this way make sure the hair could go smoothly between the supportive bulges 11, instead of being grasped between the supportive bulges 11 when doing hair curling.

When the hairs between the first plate 1 and the second plate 2 is many and thick, balance the hair between the two heaters so as the hair could be well distributed for heating and go smoothly between the heaters. Preferably, it is equipped with pressure spring 5 between the first heater 7 and the housing of the first plate 1 (that is the first housing 9), and also between the second heater 8 and the housing of the second plate 2 (that is the second housing 10). The setting of the pressure springs 5 could make the two heaters floating between the two plates for a certain range. When the hair is many and thick or is uneven distributed, the user could make the hair even and well distributed with the space widen by overcoming the elasticity of the pressure spring 5, instead of bothering to adjust the hair again by open the first plate 1 and the second plate 2.

To further optimize the use experience of user, preferably, it is equipped with 2 pressure spring 5 between the first heater 7 and the housing of the first plate, and also between the second heater 8 and the housing of the second plate. The elasticity force to be imposed upon each pressure spring 5 is 25 g-70 g (that is 0.245N-0.686N). That is the elasticity force to be imposed upon each heater is 50 g-140 g (that is 0.49N-1.372N). The experiment of the implement of the scheme verified the elasticity force, makes sure the user could make the hair between the heaters more easily, instead of damage the hair by pulling vigorously.

Since the hair curler is equipped with flexible hinge of the invention to fix the first plate 1 and the second plate 2. Therefore, the users have to overcome the elasticity force of torsion spring 6 by hand to open the plates. It is equipped with clamp 3 at the end of the first plate 1 which used for opening the first plate 1 and the second plate 2. To help the users open the plates without getting the fingers sore after the frequent use of the clamp, preferably, the pressure range of opening the plates at the clamp is at 1.8 lbs-3.8 lbs (that is 8N-1 6.89N)

To be sure, there are many kinds of ways to adjust the opening pressure at the clamp 3, such as adjust the specifications of the torsion spring 6, like the spring coefficient, material, or size; or adjust the distance from the clamp 3 to the central axis 13; or adjust the distance from the torsion spring 6 to the central axis 13. The technicians in this field could choose different method to realize the pressure adjustment.

Since the temperature of the heaters could reach 180-200° C. (356-392° F.) when heating up, the housing of the plates will be get hot because of the heat transfer. When the housing is overheated, there may be danger of causing the user's skin get burnt. To solve this problem, preferably, there are many heat evacuation holes 17 on the surface of supportive bulges 11 in the scheme. To be specific, the heat evacuation holes 17 are connected with the inner tunnel tube of the plates. The heat of the heaters will dissipate from these heat evacuation holes 17, reduce the temperature of the housing.

In order to further improve the efficiency of the heat dissipation, preferably, the inner tube of the plates are equipped with mini cooling fan in the scheme to help the heat dissipation of the inner tube of the plates.

Since the hair curler in the scheme will reduce the temperature of the housing effectively, the hairs between the plates will get curler in high temperature, while the hair on the surface of the housing will get set. Therefore the hair will get a perfect hairstyle even without the help of hair spray, the cost is saved and the hair and the scalp are less damaged.

In order to prevent the skin from getting burnt when the temperature of the housing is quite high, preferably, the both coatings of the first housing 9 and the second housing 10 are sprayed with heat sensitive color-change painting. When the temperature of the heat sensitive color-change painting reaches to the reserved value, the color of the housing will change, warming the user and avoid the touch of the user.

In addition, since most of the hairs are wet when using the hair curler, the water on the hair will turned to steam during curling, which will increase the heat transfer toward the housing. To solve the problem, preferably, there are grooves for steam emission on the first heater 7 and/or the second heater 8. To be specific, these grooves could be designed as V grooves or U grooves according to the length direction of the heaters. The high temperature of the steam could be dissipated along the groove to the air, avoid the temperature to be transferred to housing, thus reduce the temperature of the housing.

From the above mentioned implement case could be learnt that the hair curler of the invention will not get the hair clamped off when using, thus will make the hair go through the plates smoothly. Moreover, the structures, like heat sensitive color-change painting and the heat evacuation holes 17, will reduce the temperature of the housing, or warming the user, avoid the skin from get burnt, thus significant improve the safety.

The above instruction of implement cases disclosed, enable the technicians in the field to realize or use the invention. For the technicians in the field, the amendment of these implement cases will be obviously. The general principles defined in the invention can be realized in other implement cases without separate the spirit or range of the invention. Thus the invention will not be confined in the implement cases stated, but to fit most wide range of the principles and the new features disclosed in the invention.

What is claimed is:

1. A kind of hair curler, including the first plate (1) and the second plate (2), the stated first plate (1) is equipped with first heater (7), and the stated second plate (2) is equipped with the second heater (8). The feature is that when the first plate (1) and the second plate (2) are in closed condition, there will be a reserved space of 0.06 mm to 0.12 mm between the first heater (7) and the second heater (8).

2. The hair curler of claim 1, wherein the feature is the stated first plate (1) hinges the stated second plate (2) by flexible hinge. The stated flexible hinge is equipped with position limiter (14) which limits the relatively rotation of the stated first plate (1) and the stated second plate (2). The stated second plate (2) is equipped with limited step (15) which is corresponding to the stated position limiter (14).

3. The hair curler of claim 2, wherein the feature is that both ends of the stated first plate (1) and the stated second plate (2) are equipped with a supportive bulge (11). The stated supportive bulges (11) contact each other.

4. The hair curler of claim 3, wherein the feature is that the stated supportive bulges (11) are spherical bulges.

5. The hair curler of claim 1, wherein the feature is that it is equipped with pressure springs (5) between the stated first heater (7) and the stated first plate (1), and also the stated second heater (8) and the stated second plate (2).

6. The hair curler of claim 5, wherein the feature is that it is equipped with 2 stated pressure springs (5) between the first heater (7) and the stated first plate (1), and also 2 stated pressure springs (5) between the second heater (8) and the stated second plate (2). The strain range of each stated pressure spring (5) is 0.245N-0.686N.

7. The hair curler of claim 5, wherein the feature is that it is equipped with clamp (3) at the end of the stated first plate (1) which used for opening the stated first plate (1) and the stated second plate (2). The strain range of stated clamp (3) is 8N-16.89N.

8. The hair curler of claim 3 or 4, wherein the feature is that there are many heat evacuation holes (17) on the surface of stated supportive bulges (11).

9. The hair curler of claim 8, wherein the feature is that both coatings of the stated first plate (1) and the stated second plate (2) are sprayed with heat sensitive color-change painting.

10. The hair curler of claim 9, wherein the feature is that there are grooves for steam emission on the stated first heater (7) and (or) the stated second heater (8).
